(19) United States
(12) Patent Application Publication
(10) Pub. No.: US 2026/0370350 A1
(43) Pub. Date: Nov. 19, 2026

(54) LOW PROBABILITY OF INTERCEPT AND COVERT COMMUNICATIONS OVER ATMOSPHERIC TURBULENT CHANNELS

(71) Applicant: ARIZONA BOARD OF REGENTS ON BEHALF OF THE UNIVERSITY OF ARIZONA, Tucson, AZ (US)

(72) Inventors: Ivan B. Djordjevic, Tucson, AZ (US); Vijay Nafria, Tucson, AZ (US)

(21) Appl. No.: 19/487,400

(22) PCT Filed: May 25, 2024
(86) PCT No.: PCT/US2024/031174

§ 371 Date: Nov. 24, 2025

Related U.S. Application Data
(60) Provisional application No. 63/504,580, filed on May 26, 2023.

(51) Int. Cl. H04B 10/85; H04B 10/112; H04B 10/516; H04B 10/64; H04L 1/00

(52) U.S. Cl. CPC H04B 10/85; H04B 10/1121; H04B 10/5161; H04B 10/64; H04L 1/0058

(57) ABSTRACT

Disclosed are systems and techniques for covert and/or low probability to intercept communications using thermal source-based signaling. A transmitter can generate a modulated signal by modulating a low-density parity check (LDPC)-coded modulation signal on an amplified spontaneous emission (ASE) noise source signal. The modulated signal can be amplified by one or more Erbium-Doped Fiber Amplifier (EDFA) amplification stages. A noise-masked signal can be generated by combining the modulated signal with an added noise signal from an additional EDFA, and can be transmitted to a receiver via a free-space optical (FSO) link. A receiver can apply adaptive optics (AO) corrections to the received noise-masked signal and apply a narrowband filter. The transmitted signal can be detected from the narrowband filtered signal by using a balanced detector and a local laser, wherein the balanced detector uses a beam from the local laser to perform heterodyne detection.

### CROSS-REFERENCE TO RELATED APPLICATIONS

This is a PCT application that claims benefit to U.S. Provisional Application No. 63/504,580, filed May 26, 2023, which is hereby incorporated by reference, in its entirety and for all purposes.

### FIELD

The present disclosure generally relates to wireless and optical communications, and in particular relates to a system and associated method for covert and/or low probability to intercept (LPI) communications using thermal source-based signaling.

### BACKGROUND

Physical-layer security schemes are designed to protect the content of the message being transmitted over the physical communication link, rather than protecting the privacy of the end users, and this protection takes place on the physical layer. Cryptography, on the other hand is applied on the application layer. In low probability of intercept (LPI) and covert communications, various techniques can be designed and implemented to protect the privacy of the communicating parties (e.g., end users). In some existing techniques for covert and LPI communications (sometimes referred to as low probability of detection (LPD), these two concepts are considered as synonyms. In some aspects, covert communication can be considered as the most restrictive version of the broader class of LPI communication. In the most restrictive formulation of covert communication, the communication link is shut down once the transmission attempt is detected, which is not required in a generic LPI communication scenario. In covert communication, the main concern is how many covert bits can be transmitted before the communication link is shut down.

A key idea herein is to hide transmitted data behind the background solar radiation, for example by ensuring that the transmitted power is significantly below the solar radiation power in the bandwidth of interest. Moreover, similar to solar radiation, the distribution of the source used for the transmission is Gaussian. Traditional approaches employing thermal or amplified stimulated emission (ASE) noise sources for covert optical communication require the distribution of a reference signal before the homodyne detection takes place, which is not a very practical approach. To solve for this problem, the systems and techniques herein provide an approach in which detection is performed for a portion of a broadband modulation bandwidth by a local oscillator (LO) laser-based simultaneous homodyne and heterodyne detection.

### SUMMARY

The present disclosure provides a number of examples of an inventive concept including systems and methods for covert and/or low probability to intercept (LPI) communications using thermal source-based signaling. In the context of the disclosed methods, devices, techniques, apparatus, systems, and so on, the terms “operable to,” “configured to,” and “capable of” used herein are interchangeable.

In one illustrative example, a method for covert and/or low probability to intercept (LPI) communications using thermal source-based signaling is provided, the method including: generating a low-density parity check (LDPC)-coded signal; generating a modulated signal by modulating the LDPC-coded signal on an output of an amplified spontaneous emission (ASE) noise source; generating an amplified modulated signal by amplifying the modulated signal using one or more Erbium-Doped Fiber Amplifier (EDFA) amplification stages; generating a noise-masked signal by masking the amplified modulated signal by using a mixer to combine the amplified modulated signal with an added noise signal from an additional EDFA; and transmitting the noise-masked signal to a receiver, using a free-space optical (FSO) link.

In another illustrative example, an apparatus for covert and/or low probability to intercept (LPI) communications using thermal source-based signaling is provided. The apparatus includes at least one memory and at least one processor coupled to the at least one memory and configured to: generate a low-density parity check (LDPC)-coded signal; generate a modulated signal by modulating the LDPC-coded signal on an output of an amplified spontaneous emission (ASE) noise source; generate an amplified modulated signal by amplifying the modulated signal using one or more Erbium-Doped Fiber Amplifier (EDFA) amplification stages; generate a noise-masked signal by masking the amplified modulated signal by using a mixer to combine the amplified modulated signal with an added noise signal from an additional EDFA; and transmit the noise-masked signal to a receiver, using a free-space optical (FSO) link.

In some aspects, the ASE noise source comprises a thermal broadband source and an Erbium-Doped Fiber Amplifier (EDFA).

In some aspects, the thermal broadband source is used as a seed for the EDFA, and wherein an output of the EDFA seeded by the thermal broadband source comprises an ASE noise source output.

In some aspects, the method further comprises generating the modulated signal based on: providing the ASE noise source output as an optical input to a phase modulator; providing the LDPC-coded signal as an RF signal to an electrical input of the phase modulator; and generating the modulated signal by using the phase modulator to modulate the LDPC-coded signal on the ASE noise source output.

In some aspects, wherein the LDPC-coded signal is an LDPC-coded binary phase shift keying (BPSK)/M-ary PSK signal generated using an arbitrary waveform generator (AWG) or a corresponding Application-Specific Integrated Circuit (ASIC) and/or Field-Programmable Gate Array (FPGA) hardware.

In some aspects, the amplified modulated signal is generated based on: providing the modulated signal to a first amplification stage comprising an intermediate EDFA; and providing an amplified output of the intermediate EDFA to a second amplification stage comprising a final EDFA.

In some aspects, the noise-masked signal is transmitted after being provided to a beam expander.

In some aspects, the noise-masked signal is used to implement one or more of low probability to intercept (LPI) communications or covert communications.

In one illustrative example, a method for covert and/or low probability to intercept (LPI) communications using thermal source-based signaling is provided, the method including: receiving a modulated signal using a free-space optical (FSO) link; generating a filtered signal by providing the modulated signal to a narrowband filter, where the narrowband filter is configured with a passband corresponding to one or more selected wavelengths; detecting the modulated signal using a balanced detector and a local laser, wherein the balanced detector uses a beam from the local laser to perform heterodyne detection; and re-sampling a balanced detection output signal corresponding to the balanced detector, for decoding by an LDPC decoder to recover the transmitted data sequence.

In another illustrative example, an apparatus for covert and/or low probability to intercept (LPI) communications using thermal source-based signaling is provided. The apparatus includes at least one optical receiver configured to: receive a modulated signal using a free-space optical (FSO) link; select a filtered signal by providing the modulated signal to a narrowband filter, where the narrowband filter is configured with a passband corresponding to one or more selected wavelengths; detect the modulated signal using a balanced detector and a local laser, wherein the balanced detector uses a beam from the local laser to perform heterodyne detection; and re-sample a balanced detection output signal corresponding to the balanced detector, for decoding by an LDPC decoder to recover the transmitted data sequence.

In some aspects, the modulated signal is a M-ary phase shift keying (PSK) modulated signal; detecting the modulated signal utilizes an additional phase modulator provided prior to the balanced detector; an in-phase component is measured based on setting a phase shift of the phase modulator to 0 rad; and a quadrature component is measured based on setting a phase shift of the phase modulator to −π/2 rad.

In some aspects, the modulated signal is a M-ary phase shift keying (PSK) modulated signal; and detecting the modulated signal utilizes an optical splitter associated with two balanced detectors, wherein a first balanced detector corresponds to an in-phase detection branch of the optical splitter and a second balanced detector corresponds to a quadrature detection branch of the optical splitter.

In some aspects, the quadrature detection branch of the optical splitter includes the second balanced detector and a phase shifter.

In some aspects, the modulated signal is a noise-masked signal generated based on combining an added noise signal with a low-density parity check (LDPC)-coded binary phase shift keying (BPSK)/M-ary PSK signal modulated on an amplified spontaneous emission (ASE) noise source signal.

In some aspects, the added noise signal is generated using an additional EDFA; and the ASE noise source comprises a thermal broadband source and an EDFA; and the noise-masked signal is used to implement one or more of low probability to intercept (LPI) communications or covert communications.

In some aspects, the modulated signal is corrected using an adaptive optics (AO) subsystem prior to being provided to the narrowband filter, and wherein the AO subsystem corrects the modulated signal by controlling a deformable mirror based on detected turbulence or distortion on the FSO link.

In one illustrative example, a method for covert and/or low probability to intercept (LPI) communications using thermal source-based signaling is provided, the method including: generating a low-density parity check (LDPC)-coded signal; generating a modulated signal by modulating the LDPC-coded signal on an output of an amplified spontaneous emission (ASE) noise source; generating an amplified modulated signal by amplifying the modulated signal using one or more Erbium-Doped Fiber Amplifier (EDFA) amplification stages; and transmitting the amplified modulated signal to a receiver, using a free-space optical (FSO) link.

In another illustrative example, an apparatus for covert and/or low probability to intercept (LPI) communications using thermal source-based signaling is provided. The apparatus includes at least one transmitter configured to: generate a low-density parity check (LDPC)-coded signal; generate a modulated signal by modulating the LDPC-coded signal on an output of an amplified spontaneous emission (ASE) noise source; generate an amplified modulated signal by amplifying the modulated signal using one or more Erbium-Doped Fiber Amplifier (EDFA) amplification stages; and transmit the amplified modulated signal to a receiver, using a free-space optical (FSO) link.

In one illustrative example, a method for covert and/or low probability to intercept (LPI) communications using thermal source-based signaling is provided, the method including: receiving a modulated signal using a free-space optical (FSO) link; generating a filtered signal by providing the modulated signal to a narrowband filter, where the narrowband filter is configured with a passband corresponding to one or more selected wavelengths; generating a noise-added signal by mixing the filtered signal with added noise generated using one or more Erbium-Doped Fiber Amplifier (EDFA) amplification stages; and detecting the noise-added signal using a balanced detector and a local laser, wherein the balanced detector uses a beam from the local laser to perform heterodyne detection.

In another illustrative example, an apparatus for covert and/or low probability to intercept (LPI) communications using thermal source-based signaling is provided. The apparatus includes at least one optical receiver configured to: receive a modulated signal using a free-space optical (FSO) link; generate a filtered signal by providing the modulated signal to a narrowband filter, where the narrowband filter is configured with a passband corresponding to one or more selected wavelengths; and detect a noise-added signal from the filtered signal, using a balanced detector and a local laser, wherein the balanced detector uses a beam from the local laser to perform heterodyne detection.

In some aspects, the thermal noise-modulated signal is mixed with the added noise to simulate a noisy environment of a receiver of the modulated signal on the FSO link, wherein a distribution associated with the added noise is the same as a distribution associated with background radiation of the noisy environment.

In some aspects, the modulated signal is corrected using an adaptive optics (AO) subsystem; and the AO subsystem corrects the modulated signal by controlling a deformable mirror based on detected turbulence or distortion on the FSO link.

In some aspects, the modulated signal comprises a low-density parity check (LDPC)-coded signal modulated on an output of an amplified spontaneous emission (ASE) noise source, and wherein the LDPC-coded signal is an LDPC-coded binary phase shift keying (BPSK)/M-ary PSK signal.

The foregoing examples broadly outline various aspects, features, and technical advantages of examples according to the disclosure in order that the detailed description that follows may be better understood. It is further appreciated that the above operations described in the context of the illustrative example method, device, and computer-readable medium are not required and that one or more operations may be excluded and/or other additional operations discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

FIG. 1 is a simplified diagram showing an example free-space optical (FSO) transmission system using adaptive optics (AO) and an amplified spontaneous emission (ASE) noise source with binary phase shift keying (BPSK), in accordance with some examples;

FIG. 2 is a simplified diagram showing an example of: (left) a transmitter configuration for covert/LPI communication and (right) a receiver configuration for covert/LPI communication including a scheme for bit error rate (BER) vs. receiver side optical signal-to-noise ratio (OSNR) measurements, in accordance with some examples;

FIG. 3 is a simplified diagram showing an example of:: (left) a transmitter configuration and (right) a receiver configuration including a scheme for low probability to intercept (LPI) where noise masking is applied on the transmitter side, in accordance with some examples;

FIG. 4A is a graph of BER vs. receiver side OSNR, in accordance with some examples; and FIG. 4B is a graph of BER vs. transmitter OSNR in a LPI scheme with transmit noise masking, in accordance with some examples.

Corresponding reference characters indicate corresponding elements among the view of the drawings. The headings used in the figures do not limit the scope of the claims.

### DETAILED DESCRIPTION

Aspects of the present disclosure provide systems and methods for covert and/or low probability to intercept communications using thermal source-based signaling. Described are results from an example one-mile-long free-space optical (FSO) low probability to intercept (LPI) communication link for an amplified spontaneous emission (ASE) noise source-based 5 Gb/s binary phase shift keying (BPSK) signal. Further disclosed are improvements in the bit error rates (BERs) from using adaptive optics (AO) to compensate for wavefront distortions in medium atmospheric turbulence on the FSO communication link.

The description below makes reference to an example one mile-long FSO communication link established between a source location (e.g., the Electrical and Computer Engineering (ECE) building on the University of Arizona campus) and an intermediate location (e.g., the Optical Sciences (OSC) building on the University of Arizona campus) on the University of Arizona campus. Described below is an experimental demonstration of successful transmission of an ASE noise source based low-density parity check (LDPC)-coded 5 Gb/s BPSK signal over the 1-mile FSO link, where the 1-mile FSO link is subjected to atmospheric turbulence effects and Mie scattering. Also demonstrated is an improvement in BER performance achieved by aspects of the present disclosure, based on the application of adaptive optics to compensate for wavefront distortion on the FSO communication link due to atmospheric turbulence. In some embodiments, aspects of the present disclosure can be used to implement low probability to intercept (LPI) communications and/or can be used to implement covert communications.

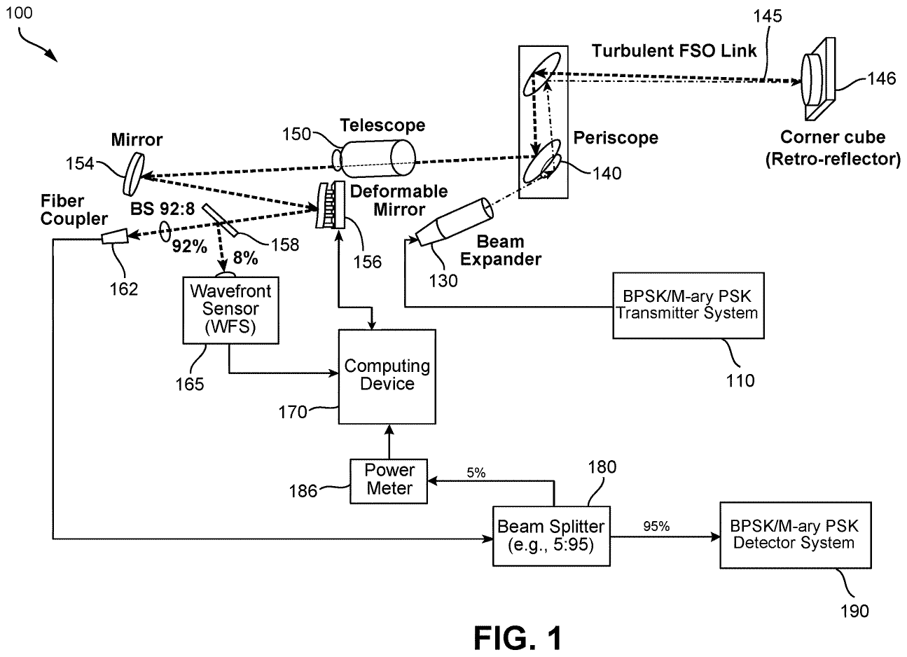

FIG. 1 is a simplified diagram showing an example free-space optical (FSO) transmission system 100 that can be used to implement covert and/or LPI communications using thermal source-based signaling. In some aspects, the transmission system 100 can also be referred to as an entanglement assisted (EA) communication system, and/or an entanglement distribution system. The transmission system 100 of FIG. 1 can implement the cover and/or LPI communications by using thermal source-based signaling, alone or in combination with receiver-side adaptive optics (AO). In some embodiments, the thermal source-based signaling can utilize or include an amplified spontaneous emission (ASE) noise source with binary phase shift keying (BPSK), in accordance with some examples.

In one illustrative example, the transmission system 100 of FIG. 1 corresponds to an example optical setup for an amplified spontaneous emission (ASE) noise source-based binary phase shift keying (BPSK) free-space optical (FSO) transmission system with adaptive optics (AO), in accordance with some examples. In some embodiments, the transmission system 100 can have a data rate of 5 Gb/s, although it is noted that the example 5 Gb/s data rate is chosen for illustrative purposes, and is not intended to be construed as limiting. For instance, data rates other than 5 Gb/s (e.g., greater or lesser) may also be utilized without departing from the scope of the present disclosure (e.g., such as 10 Gb/s or 20 Gb/s data rate, etc.).

It is additionally noted that the example of a BPSK modulation scheme is provided for illustrative purposes, and various other modulation schemes can also be utilized without departing from the scope of the disclosure (e.g., BPSK can be replaced with a quadrature phase-shift keying (QPSK) scheme, etc.). More generally, in some embodiments it is contemplated that the systems and techniques described herein can be utilized and/or implemented with any constant amplitude modulation scheme, including BPSK, QPSK, M-ary PSK (with M>2), etc., among various others.

As shown in FIG. 1, the covert/LPI communication system 100 can be divided into two physical locations. A transmitter component (e.g., the BPSK transmitter system 110), a beam transmission/collection component (e.g., including one or more or all of the beam expander 130, the periscope 140, the telescope 150, the turbulent FSO link 145, and/or the corner cube retroreflector 146, etc.), and adaptive optics (AO) subsystems (e.g., including one or more or all of the deformable mirror 156, the wavefront sensor (WFS) 165, the computing device 170, and/or the power meter 186, etc.) are provided at a first location. In some examples and/or experimental or system configurations, the first location is ECE room 549 on the University of Arizona campus.

The covert/LPI communication system 100 further includes detection and decoder subsystems, which may be provided at a second location (e.g., ECE room 441 on the University of Arizona campus) that is separate and distance from the first location. As will be described in greater detail below, the detection and decoder subsystems can include one or more (or all) of the beam splitter 180 and the BPSK detector system 190.

In some embodiments, a retro reflector corner cube 146, with a beam divergence of 30 arcsec, is placed at a third location, also referred to as an intermediate location, an intermediate node, a relay location, etc. In some examples, the third location at which the retroreflector 146 is placed is given as the rooftop of the OSC Meinel building on the University of Arizona campus.

In some aspects, a properly designed mirror or reflector (e.g., including, but not limited to, the retroreflector 146) at the third/intermediate node location can be used to redirect a beam transmitted from the BPSK transmitter system 110 at the first location (e.g., ECE room 549) to an additional location that is different from both the first location and the third location (e.g., the additional location for the relay from the intermediate node mirror or reflector 146 can be the receiver-side at the second location, can be a separate and distinct fourth location, etc.).

The purpose of this arrangement is to provide the low probability to intercept (LPI) and/or covert communications according to aspects of the present disclosure, and more particularly, to provide the LPI and/or covert communications disclosed herein in embodiments, examples, or scenarios where there is no direct line-of-sight between the transmitter (e.g., the BPSK transmitter system 110 and associated optical and/or transmission components of the system 100) and the corresponding receiver that is associated with the transmitter (e.g., the BPSK detector system 190 and associated optical and/or receiving/detection components of the system 100).

To facilitate demonstration, here the fourth location coincides with the first location, and the redirecting mirror is replaced by a corner-cube retroreflector 146 that is used to double the length of the turbulent FSO channel 145 over which the signals propagate or travel (e.g., the length of the turbulent FSO path is doubled based on the retroreflector 146 causing photons to travel a round-trip path along the turbulent FSO link 145 from the periscope 140 to the retroreflector 146, and subsequently a return leg along the turbulent FSO link 145 from the retroreflector 146 back to the periscope 140).

However, it is noted that the fourth location and the first location can differ from one another, without departing from the scope of the present disclosure. The employment of multiple locations (nodes) illustrates the possibility of heterogenous LPI/covert networking, in which the optical links could be either FSO or fiber links, or any combination(s) or sub-combination(s) thereof.

In the context of the example covert/LPI system 100 depicted in FIG. 1, the transmitter-side components provided at the first location can include all components other than the corner cube retro-reflector 146 and the BPSK detector system 190. For instance, the transmitter-side can include a BPSK transmitter system 110 coupled to a beam expander 130 and a periscope 140. The combination of the beam expander 130 and the periscope 140 can be referred to as an “optical transmitter.” The output of the BPSK transmitter system 110 is provided to the beam expander 130, which is coupled to a transmit portion or transmit path/configuration of the periscope 140. For example, the periscope subsystem 140 can be used to separate transmit and receive beams.

In some aspects, the BPSK transmitter system 110 can generate a modulated BPSK signal for transmission by the beam expander 130. The beam transmitted from the beam expander 130 (e.g., based on the modulated BPSK signal from the BPSK transmitter system 110) can be transmitted via the periscope 140 towards the third (intermediate) location at which the corner cube retroreflector 146 is located. In one illustrative example, the beam is transmitted from the beam expander 130 to the third (intermediate) location and the retroreflector 146 over a turbulent free-space optical (FSO) link 145. The transmitted beam is then reflected back via the corner cube retroflector 146 and toward the destination location (e.g., node) associated with the configured receiver of the covert/LPI communication system 100.

The same periscope 40 used to transmit the beam from the BPSK transmitter system 110 and beam expander 130 can also be used to first receive the reflected beam from the corner cube retroreflector 146. For example, the periscope subsystem 140 may be composed of three mirrors, for example a first and second 6-inch mirror provided at the top and bottom, respectively, of the periscope 140, and one 2-inch mirror provided at the bottom of the periscope 140. The top mirror of the periscope 140 can be a shared (e.g., common) mirror used in, by, or for both a transmit configuration of the periscope 140 and a receive configuration of the periscope 140.

For instance, in the transmit configuration of the periscope 140, the smaller (e.g., 2-in) bottom mirror and the shared top mirror can be used to transmit the transmitted beam from the periscope 140 and beam expander 130/BPSK transmitter system 110 to the retroreflector 146. In the receive configuration of the periscope 140, the shared top mirror and the larger (e.g., 6-in) bottom mirror can be used to receive the received beam from the retroreflector 146 to the periscope 140. In some embodiments, the transmit and receive configurations of the periscope 140 can be combined into a single periscope or single periscope housing. In some examples, the transmit configuration of the periscope 140 can be provided by a transmit periscope that is separate from a receive periscope/the receive periscope configuration.

From the receive periscope (e.g., receive configuration of the periscope 140), the received beam may be provided to a receive telescope 150. The receive telescope 150 can be a compressing telescope, for example used to reduce the size of the received beam. From the receive telescope (e.g., compressing telescope) 150, the received beam reflects off of a first mirror 154 and is provided next to a deformable mirror 156 of an adaptive optics (AO) subsystem.

The AO subsystem can be used to perform compensations for turbulence on the FSO link 145 between the optical transmitter and the optical receiver of the covert/LPI communication system 100 of FIG. 1. For instance, after exiting the compressing telescope 150, the received beam (e.g., reflected beam from the retroreflector 146) propagates over the optical bench with the AO setup (e.g., AO sub-system). The AO subsystem includes a wavefront sensor (WFS) 165 and a deformable mirror (DM) 156, operating in a servo loop. The WFS 165 can be configured and used to look for (e.g., detect, measure, and/or identify) wavefront distortions in one or more portions of the received beam that is provided to the WFS 165 from a beam splitter 158 on the output of the deformable mirror 156.

In some embodiments, the received beam can exit the compressing telescope 150, be reflected by the first mirror 154 to the deformable mirror 156 of the AO subsystem, and then provided to a beam splitter (BS) 158. The beam splitter 158 can split the beam between a fiber coupler 162 (e.g., configured to provide a coupling of the received beam to a BPSK detector system 190 located at the second location e.g., “ECE Rm 441”) and the WFS 165 of the AO sub-system. In some embodiments, the beam splitter 158 can use a 92% to 8% split of the incoming beam, with 92% being provided to the fiber coupler 162 beam splitter output path for subsequent BPSK detection at the BPSK detector system 190, and with the remaining 8% being provided to the WFS 165 beam splitter output path for wavefront distortion detection and implementation of corresponding corrections using the deformable mirror 156 of the AO subsystem.

A correction or compensation can be applied by the AO sub-system (e.g., applied by the particular deformations implemented at the deformable mirror 156) to compensate for turbulence on the FSO link 145 and/or to compensate and remove the wavefront distortion detected by the WFS 165. In particular, the WFS 165 can be used to identify one or more wavefront distortions in the portion of the received beam that is provided to the WFS 165 from the beam splitter 158. One or more computing devices 170 coupled to the WFS 165 can subsequently be used to calculate the corresponding correction signals for the one or more wavefront distortions identified by the WFS 165. The corresponding correction signals calculated by the computing device 170 can be applied to deform the deformable mirror 156 in order to compensate for the wavefront distortions introduced or caused by turbulence and/or scattering on the turbulent FSO link 145.

Notably, according to aspects of the present disclosure, it is contemplated that the AO correction(s) for the deformable mirror 156 can be performed or otherwise applied directly on the modulated signal originating from the BPSK/QPSK transmitter system 110. For example, the AO corrections can be performed directly on the reflection of the modulated signal generated by the BPSK/QPSK transmitter system 110 and reflected on a path to the deformable mirror 156 from the retroreflector 146, without needing a reference signal or probe to characterize the FSO link 145 for purposes of the AO correction. This is true for any constant amplitude modulation scheme (any of which may be utilized herein, as noted previously above), such as M-ary PSK, etc., with BPSK being an example case described herein for illustrative purposes and without intent to be construed as limiting.

In some aspects, the AO correction can be performed directly on the modulated BPSK signal originating from and/or generated by the BPSK transmitter system 110, based on the modulated BPSK signal being a constant amplitude signal. Various other constant modulation types and/or schemes can also be utilized to generate the modulated signal for transmission by the periscope 140 (e.g., other than or in addition to BPSK). In examples where the transmitter system does not use constant amplitude modulation (e.g., examples where the transmitter system 110 uses a modulation scheme such as 8-QAM or 16-QAM, etc.), a reference signal or probe may be needed (e.g., may be included in the signal or beam transmitted from the periscope 140 to the corner cube retroreflector 146 for subsequent reflection onward to the deformable mirror 156 and detection paths/detector system 190) in order to perform the AO correction and channel turbulence compensation described herein.

The portion of the received/reflected beam at the receiver-side that is provided to the fiber coupler 162 from the beam splitter (BS) 158 (e.g., the 92% portion of the reflected beam) is corrected based on the immediately prior correction (e.g., deformation) that was applied to the deformable mirror 156. In one illustrative example, the covert/LPI communication system 100 of FIG. 1 can perform greater than 350 AO corrections per second. The portion of the reflected beam provided to the fiber coupler 162 from the deformable mirror 156 and beam splitter 158 can also be referred to as the “corrected beam.”

The fiber coupler 162 can couple the corrected beam into a fiber optic line to the BPSK detector system 190 at the second location (e.g., “ECE Rm 441”). An additional (e.g., second) beam splitter 180 is provided on the fiber optic line, between the fiber coupler 162 and the BPSK detector system 190. For instance, the additional beam splitter 180 can be used to split the corrected beam into a first portion and a second portion. As shown in FIG. 1, the first portion can be 95% of the corrected beam and the second portion can be 5% of the corrected beam. The corrected beam is propagated over the fiber link to another location (ECE Rm 441) where the BPSK detector system 190 is placed.

In particular, the first portion of the corrected beam (e.g., the 95% portion split by the additional beam splitter 180 on the fiber optic line to the BPSK detector system 190) can be provided to the BPSK detector system 190. The second portion of the corrected beam (e.g., the remaining 5% portion split by the additional beam splitter 180 on the fiber optic line) can be provided to a power meter 186 that is coupled to the same computing device 170 used to control the AO subsystem and deformable mirror 156. For instance, the 5% second portion of the corrected beam can be used by the computing device 170 to monitor channel conditions of the FSO link 145 between the periscope 140 and the corner cube retroreflector 146 (e.g., to monitor turbulence conditions on the FSO link 145). The implementation of channel monitoring at the computing device 170 can be separate from the implementation of adaptive optics at the computing device 170.

Two configurations of the example covert/LPI communication systems disclosed herein (e.g., the same as or similar to, and/or configured to be implemented by the covert/LPI communication system 100 of FIG. 1) are described below.

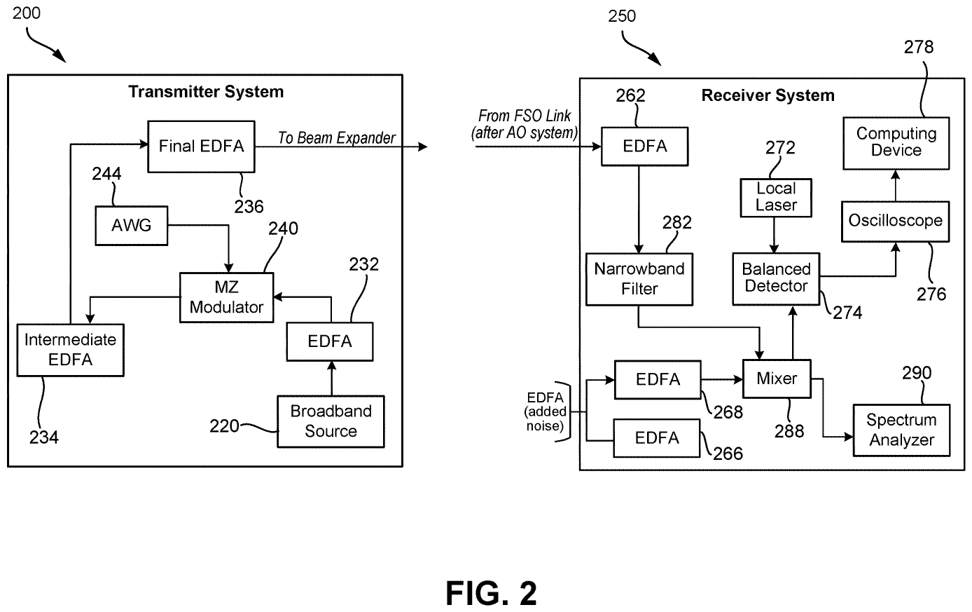

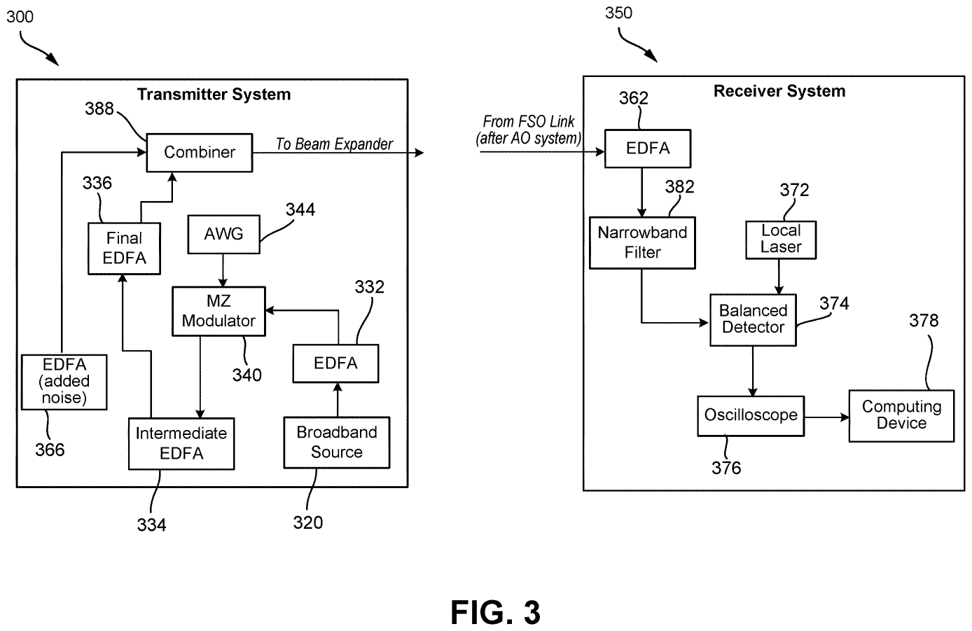

In the first configuration, shown in greater detail in FIG. 2, added noise is loaded on the receiver side associated with a receiver system 250 (e.g., after/downstream of a narrowband filter 282 included within the receiver system 250). For instance, the added noise can be loaded on the receiver-side 250 after the narrowband filter 282, and may be used to perform bit-error rate (BER) vs. optical signal-to-noise ratio (SNR) (OSNR) measurements. In the second configuration, shown in greater detail in FIG. 3, added noise in the form of ASE noise is added on the transmitter side associated with a transmitter system 300 and used to mask the presence of the information-bearing communication signal.

The left sides of both FIGS. 2 and 3 are block-diagram depictions of the transmitter-side components located at the first location (e.g., ECE room 549) described above with respect to the covert/LPI communication system 100 of FIG. 1. In other words, the left-hand side “transmitter” scheme components included within the transmitter system 200 of FIG. 2 and/or those included within the transmitter system 300 of FIG. 3 can be used to implement the BPSK transmitter system 110 of FIG. 1. Similarly, the right-hand side “receiver” components included within the receiver system 250 of FIG. 2 and/or those included within the receiver system 350 of FIG. 3 can be used to implement the BPSK detector system 190 of FIG. 1.

The information sent using the transmitter-side components (e.g., the output of BPSK transmitter system 110 provided in the transmitted beam from the periscope 140 of FIG. 1; the “To Beam Expander” input from the final EDFA 236 of the transmitter system 200 of FIG. 2; and/or the “To Beam Expander” from the combiner 388 of the transmitter system 300 of FIG. 3) can be implemented as a low-density parity check (LDPC)-coded binary phase shift keying (BPSK) signal at 5 Gb/s or higher using an arbitrary waveform generator (AWG), FPGA, ASIC, etc. For example, the transmitter system 200 of FIG. 2 includes an AWG 244, which may be the same as or similar to the AWG 344 included in the transmitter system 300 of FIG. 3. The code rate for a FEC frame for LDPC is 0.75 with a codeword length of 4320 and an information word length of 3242. The data are organized in frames composed of a header (known to the receiver) and the LDPC encoded sequence.

A thermal broadband source is used as a seed for an Erbium-Doped Fiber Amplifier (EDFA) that serves the role of an amplified spontaneous emission (ASE) noise source that will be associated with or combined with the LDPC-coded BPSK signal from the AWG. For example, in the context of the transmitter system 200 of FIG. 2, a thermal broadband source 220 is used as a seed for an EDFA 232 that serves the role of an ASE noise source associated with or combined with an LDPC-coded BPSK signal from the AWG 244 and/or phase modulator (e.g., “MZ Modulator” operated as the phase modulator) 240 included in the transmitter system 200. In another illustrative example, in the context of the transmitter system 300 of FIG. 3, a thermal broadband source 320 is used as a seed for an EDFA 332 that serves the role of an ASE noise source that is associated with or combined with an LDPC-coded BPSK signal from the AWG 344 and/or phase modulator (e.g., “MZ Modulator” operated as the phase modulator) 340 included in the transmitter system 300. In some embodiments, the thermal broadband source 220 of FIG. 2 can be the same as or similar to the thermal broadband source 320 of FIG. 3; the EDFA 232 of FIG. 2 can be the same as or similar to the EDFA 332 of FIG. 3; the AWG 244 of FIG. 2 can be the same as or similar to the AWG 344 of FIG. 3; and/or the MZ modulator 240 of FIG. 2 can be the same as or similar to the MZ modulator 340 of FIG. 3; etc.

In one illustrative example, the ASE noise source comprising the thermal broadband source 220, 320 and the EDFA 232, 332 is used as an optical input of a phase modulator 240, 340 (e.g., the “MZ Modulator” operated as the phase modulator). The RF input of the phase modulator 240, 340 can be an RF signal, such as the LDPC-coded BPSK signal from the AWG 244, 344. The phase modulator 240, 340 optical output is subsequently amplified in two stages to 120 mW.

For example, a first amplification stage can be provided by the intermediate EDFA 234 of FIG. 2 and/or the intermediate EDFA 334 of FIG. 3, where the intermediate EDFA 234, 334 and corresponding first amplification stage implemented by the intermediate EDFA 234, 334 is used to compensate for an insertion loss of the phase modulator 240, 340.

A second amplification stage can be provided by the final EDFA 236 coupled to the output of the intermediate EDFA 234 of FIG. 2, and/or by the final EDFA 336 coupled to the output of the intermediate EDFA 334 of FIG. 3. The output of the final EDFA 236 (e.g., and/or the second amplification stage applied to the phase modulator 240, 340 output) can be provided as an output of the transmitter system 200, 300 and may connected to a beam expander (e.g., such as the beam expander 130 of FIG. 1) and can also be referred to as a “booster (or high-power) EDFA output.”

In some embodiments, the booster (high-power) EDFA output is used as the input of a beam expander, which points towards either the redirecting mirror or a retroreflector corner cube (e.g., such as the retroreflector or redirecting/relay mirror 146 of FIG. 1, etc.) placed at the second location (e.g., on the rooftop of the OSC Meinel building). In other words, the booster EDFA output of FIG. 2 or 3 can be the same as the transmitted beam from the periscope 140 of FIG. 1. The beam reflected back towards the transmitter-side location/first location (e.g., ECE room 549) is collected by the compressing telescope 150 of FIG. 1.

The right-hand side components of FIGS. 2 and 3 can correspond to two different configurations that can be used to implement the BPSK detector system 190 of FIG. 1, as previously noted above. For example, FIG. 2 includes the receiver system 250 components which may be used to implement the BPSK detector system 190 of FIG. 1, and FIG. 3 includes the receiver system 350 components which may be used to implement the BPSK detector system 190 of FIG. 1. In both configurations, the incoming FSO link beam (e.g., shown at the top left as an input signal to the respective receiver system 250, 350) first goes through the AO bench setup, which is shown in the left half of the covert/LPI communication system 100 of FIG. 1.

As noted previously, the AO subsystem is based on a deformable mirror (DM) 156 that works together with a wavefront sensor (WFS) 165 in a servo loop. The wavefront distortions are observed by the WFS 165 and AO corrections, which are calculated by the computing device 170, are applied to the DM 156 at a rate of ~350 frames/s. The output from the AO subsystem is then provided to the receiver subsystem 250 of FIGS. 2 and/or 350 of FIG. 3 (e.g., the BPSK detector system 190 of FIG. 1).

In the receiver subsystem 250, 350, the output from the AO subsystem (e.g., the corrected beam reflection) can be first amplified by an input EDFA 262, 362 (respectively) that is configured and used to compensate for scattering and absorption loss of the FSO link over which the beam is transmitted. The amplified output of the input EDFA 262, 362 is then passed through a narrowband filter 282, 382 to facilitate balanced detection with the help of a local laser operating at 1550 nm in a heterodyne detection scheme. For example, the output of the input EDFA 262, 362 can be provided as input to the narrowband filter 282, 382. The output of the narrowband filter 282, 382 can be provided as input to a balanced detector 274, 374 included in the receiver systems 250, 350 of FIGS. 2 and 3 (respectively). The balanced detector 274, 374 can be configured to perform balanced detection based on a respective first input from the narrowband filter 282, 382 and a respective additional/second input comprising a signal from a local laser 272, 372 (e.g., a local laser of the receiver system 250, 350 operating at 1550 nm wavelength in a heterodyne detection scheme, etc.).

In some embodiments, the narrowband filter 282, 382 can be used to select a particular wavelength for demodulation at the receiver system 250, 350. The narrowband filter 282, 382 can also filter out the noise outside of the modulation bandwidth. In some aspects, if the modulation bandwidth is comparable to the bandwidth of balanced detector 274, 374, the narrowband filter 282, 382 can be omitted from the receiver system 250, 350. Balanced detection can be performed using the combination of the balanced detector 2574, 374 of the receiver schemes 250, 350 and the respective local laser 272, 372 of each receiver scheme 250, 350.

In the first configuration for the BPSK transmitter and detector/receiver systems of FIG. 1—e.g., the transmitter scheme 200 and the receiver scheme 250 depicted in FIG. 2—after the narrowband filter 282 is applied, one or more additional EDFAs 266 and 268 can be provided on the receiver side and used to add noise. For instance, the two EDFAs 266 and 268 included in the receiver system 250 of FIG. 2 can correspond to or can be included in an “EDFA (Added Noise)” subsystem of the receiver 250.

In one illustrative example, the two EDFAs 266 and 268 (e.g., the EDFA added noise subsystem of the receiver 250) can be used to add noise, e.g., such that the systems and techniques described here can be used to emulate variations in optical signal-to-noise ratio (OSNR). In one illustrative example, the added noise from the two EDFAs 266 and 268 can be combined with the output of the narrowband filter 282 using a mixer 288 (also referred to as a “combiner 288”, e.g., in some aspects the “mixer” 288 shown in FIG. 2 can be implemented as a combiner). The output of the mixer 288 is the narrowband filtered signal (e.g., from the narrowband filter 282) mixed or otherwise combined with the added EDFA noise from the two additional noise EDFAs 266 and 268 included in the EDFA added noise subsystem of the receiver 250 of FIG. 2.

From the mixer 288, the narrowband filtered signal with added EDFA noise can be provided to the balanced detector 274 as described above. The inputs to the balanced detector 274 of the receiver system 250 of FIG. 2 are from the local laser 272 and the narrowband signal with added EDFA noise from the mixer 288. The balanced detection output from the balanced detector 274 can be used for bit error rate (BER) vs. receive-side OSNR measurements, based on the balanced detection output from the balanced detector 274 being provided as input to the real-time oscilloscope (or A/D converter) 276 and the computing device 278 included in the receiver system 250 of FIG. 2. The balanced detector 274 can be configured with the optical hybrid to mix the received signal carrying the BPSK/QPSK information (e.g., from the narrowband filter 282) and a local oscillator laser signal from the local laser 272 serving as the reference. If the balanced detector 274 does not have an optical hybrid incorporated inside the module, an additional optical hybrid in front of the balanced detector 274 is needed. For M-ary PSK modulation and decoding, an additional phase modulator in front the balanced detector 274 is needed to measure the in-phase component by setting the phase shit to 0 rad and to measure the quadrature component by setting the phase shift to −π/2 rad. Alternatively, an optical splitter can be included in the receiver system 250 and used with two balanced detectors 274 corresponding to the in-phase and quadrature components and a phase shifter in the quadrature detection branch.

In some embodiments, the output of the balanced detector 274 (e.g., the balanced detection output) can be sampled at 100 GSa/s by an analog-to-digital convertor (ADC) of the real-time oscilloscope 276 of FIG. 2 and subsequently stored on or by computing device 278 of FIG. 2 for offline digital signal processing (DSP) and LDPC decoding. In some cases, to simplify the DSP operations associated with or implemented by the receiver system 250 of FIG. 2, various cross-correlation methods can first be applied to determine the ‘header’ of the bit frame, followed by LDPC decoding.

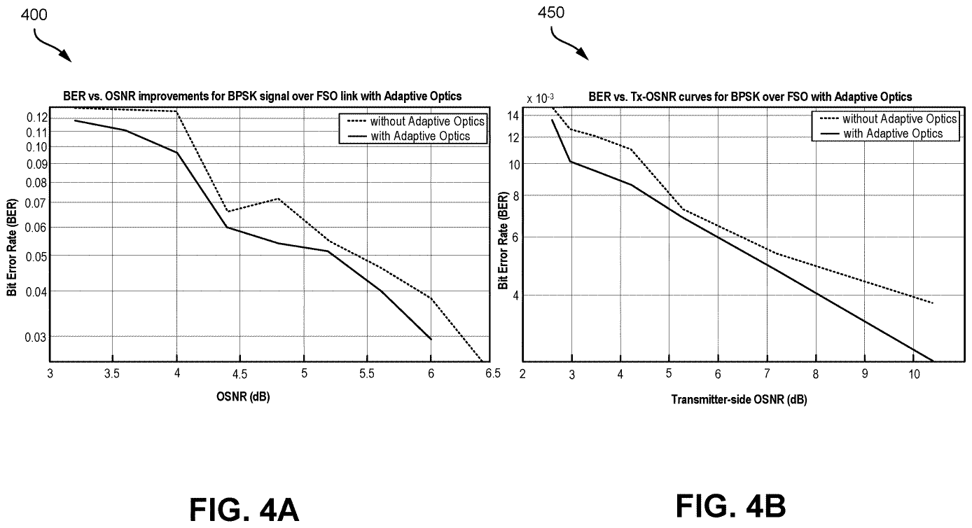

FIG. 4A is a graph 400 of bit-error rate (BER) vs. receiver-side optical signal-to-noise ratio (OSNR), in accordance with some examples. FIG. 4B is a graph 450 of BER vs. transmitter-side OSNR in an LPI scheme with transmit noise masking, in accordance with some examples. In particular, the graph of FIG. 4A summarizes the experimental results with noise added on the receiver side (e.g., corresponding to the implementation of FIG. 2, in which the receiver system 250 includes the EDFA added noise subsystem comprising the additional noise EDFAs 266 and 268) to evaluate the uncoded BER vs. receive-side OSNR performance for 5 Gb/s BPSK signaling over a 1-mile FSO link in the presence of medium turbulence.

The graph 450 of FIG. 4B summarizes the experimental results corresponding to an LPI scheme in which transmit-side noise masking is applied (e.g., corresponding to the implementation of FIG. 3, in which the transmitter system 300 includes the added noise EDFA 366), also in the presence of medium turbulence over the 1-mile FSO link. In both graphs 400 and 450 (e.g., in both FIGS. 4A and 4B, respectively), the dashed lines correspond to uncoded BPSK when AO is not used (e.g., “without Adaptive Optics”), while the solid lines correspond to uncoded BPSK signaling over the FSO link when AO is used (e.g., “with Adaptive Optics”). It can be seen that the presently disclosed systems and techniques that implement AO provide improvements in BER performance in both scenarios for all OSNR values under study. All errors introduced by the turbulent channel and noise addition in this experiment have been successfully corrected by the LDPC code, demonstrating that error-free transmission is possible.

In some aspects, the ASE-noise based BPSK signaling scheme with transmit-side noise masking (e.g., the example configuration of FIG. 3, in which the transmitter system 300 includes the added noise EDFA 366) can be used in both LPI and covert communications. To illustrate, the solar background radiation was measured in the early afternoon to be 10 mW in a 10 mm aperture in C-band and average Alice-to-Bob transmittance to be 5%. Willie will need to use a drone to monitor the link and his transmittance cannot be better than that of Bob. Based on covert communication theory, for Willie's BER to be higher than 0.4, the maximum transmit power for the FSO link to be covert is 168.8 mW, indicating that the FSO link described herein is covert.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A method comprising:
generating a low-density parity check (LDPC)-coded signal;
generating a modulated signal by modulating the LDPC-coded signal on an output of an amplified spontaneous emission (ASE) noise source;
generating an amplified modulated signal by amplifying the modulated signal using one or more Erbium-Doped Fiber Amplifier (EDFA) amplification stages;
generating a noise-masked signal by masking the amplified modulated signal by using a mixer to combine the amplified modulated signal with an added noise signal from an additional EDFA; and
transmitting the noise-masked signal to a receiver, using a free-space optical (FSO) link.

2. The method of claim 1, wherein the ASE noise source comprises a thermal broadband source and an Erbium-Doped Fiber Amplifier (EDFA).

3. The method of claim 2, wherein the thermal broadband source is used as a seed for the EDFA, and wherein an output of the EDFA seeded by the thermal broadband source comprises an ASE noise source output.

4. The method of claim 3, further comprising generating the modulated signal based on:
providing the ASE noise source output as an optical input to a phase modulator;
providing the LDPC-coded signal as an RF signal to an electrical input of the phase modulator; and
generating the modulated signal by using the phase modulator to modulate the LDPC-coded signal on the ASE noise source output.

5. The method of claim 1, wherein the LDPC-coded signal is an LDPC-coded binary phase shift keying (BPSK)/M-ary PSK signal generated using an arbitrary waveform generator (AWG).

6. The method of claim 1, wherein the amplified modulated signal is generated based on:
providing the modulated signal to a first amplification stage comprising an intermediate EDFA; and
providing an amplified output of the intermediate EDFA to a second amplification stage comprising a final EDFA.

7. The method of claim 1, wherein the noise-masked signal is transmitted after being provided to a beam expander.

8. The method of claim 1, wherein the noise-masked signal is used to implement one or more of low probability to intercept (LPI) communications or covert communications.

9. A method comprising:
receiving a modulated signal using a free-space optical (FSO) link;
generating a filtered signal by providing the modulated signal to a narrowband filter, where the narrowband filter is configured with a passband corresponding to one or more selected wavelengths;
detecting the modulated signal using a balanced detector and a local laser, wherein the balanced detector uses a beam from the local laser to perform heterodyne detection; and
re-sampling a balanced detection output signal corresponding to the balanced detector, for decoding by an LDPC decoder to recover the transmitted data sequence.

10. The method of claim 9, wherein:
the modulated signal is a M-ary phase shift keying (PSK) modulated signal;
detecting the modulated signal utilizes an additional phase modulator provided prior to the balanced detector;
an in-phase component is measured based on setting a phase shift of the phase modulator to 0 rad; and
a quadrature component is measured based on setting a phase shift of the phase modulator to −π/2 rad.

11. The method of claim 9, wherein:
the modulated signal is a M-ary phase shift keying (PSK) modulated signal; and
detecting the modulated signal utilizes an optical splitter associated with two balanced detectors, wherein a first balanced detector corresponds to an in-phase detection branch of the optical splitter and a second balanced detector corresponds to a quadrature detection branch of the optical splitter.

12. The method of claim 11, wherein the quadrature detection branch of the optical splitter includes the second balanced detector and a phase shifter.

13. The method of claim 9, wherein the modulated signal is a noise-masked signal generated based on combining an added noise signal with a low-density parity check (LDPC)-coded binary phase shift keying (BPSK)/M-ary PSK signal modulated on an amplified spontaneous emission (ASE) noise source output.

14. The method of claim 13, wherein:
the added noise signal is generated using an additional EDFA; and
the ASE noise source comprises a thermal broadband source and an EDFA; and
the noise-masked signal is used to implement one or more of low probability to intercept (LPI) communications or covert communications.

15. The method of claim 9, wherein the modulated signal is corrected using an adaptive optics (AO) subsystem prior to being provided to the narrowband filter, and wherein the AO subsystem corrects the modulated signal by controlling a deformable mirror based on detected turbulence or distortion on the FSO link.

16. A method comprising:
generating a low-density parity check (LDPC)-coded signal;
generating a modulated signal by modulating the LDPC-coded signal on an output of an amplified spontaneous emission (ASE) noise source;
generating an amplified modulated signal by amplifying the modulated signal using one or more Erbium-Doped Fiber Amplifier (EDFA) amplification stages; and
transmitting the amplified modulated signal to a receiver, using a free-space optical (FSO) link.

17. A method comprising:
receiving a modulated signal using a free-space optical (FSO) link;
generating a filtered signal by providing the modulated signal to a narrowband filter, where the narrowband filter is configured with a passband corresponding to one or more selected wavelengths; and
detecting a noise-added signal from the filtered signal, using a balanced detector and a local laser, wherein the balanced detector uses a beam from the local laser to perform heterodyne detection.

18. The method of claim 17, wherein the filtered signal is mixed with the added noise to simulate a noisy environment of a receiver of the modulated signal on the FSO link.

19. The method of claim 17, wherein:
the modulated signal is corrected using an adaptive optics (AO) subsystem; and
the AO subsystem corrects the modulated signal by controlling a deformable mirror based on detected turbulence or distortion on the FSO link.

20. The method of claim 17, wherein the modulated signal comprises a low-density parity check (LDPC)-coded signal modulated on an output of an amplified spontaneous emission (ASE) noise source, and wherein the LDPC-coded signal is an LDPC-coded binary phase shift keying (BPSK)/M-ary PSK signal.
